(19) United States
(12) Patent Application Publication
(10) Pub. No.: US 2016/0063108 A1
(43) Pub. Date: Mar. 3, 2016

(54) INTELLIGENT QUERY FOR GRAPHIC PATTERNS

(71) Applicant: General Electric Company, Schenectady, NY (US)

(72) Inventors: Chih-Sung Wu, Dublin, CA (US); Chih-Pin Hsiao, Chamblee, GA (US); Jeng-Weei Lin, Danville, CA (US); Na Cheng, Dublin, CA (US); Waqas Javed, San Leandro, CA (US)

(21) Appl. No.: 14/472,182

(22) Filed: Aug. 28, 2014

(51) Int. Cl. G06F 17/30; G06F 3/0488; G06F 3/0486; G06F 3/0484

(52) U.S. Cl. CPC G06F 17/30864; G06F 3/04847; G06F 3/04842; G06F 3/04883; G06F 3/0486; G06F 17/30389; G06F 17/30557

(57) ABSTRACT

A system and method for facilitating an intelligent query for graphic pattern is provided. In example embodiments, a plurality of user interfaces is provided at a first device that is communicatively coupled to a second device having a visual analytics system. The plurality of user interfaces provides control of the visual analytics system of the second device at the first device. Sketch inputs are received via a sketch user interface of the plurality of user interfaces. The sketch inputs collectively generate a graphic pattern. A complex query is generated that includes the graphic pattern. The complex query is transmitted to the second device having the visual analytics system that performs a search for data that matches the complex query.

### FIELD

The present disclosure relates generally to data queries and, in a specific example embodiment, to performing intelligent query for graphic patterns.

### BACKGROUND

Traditional text-based queries have been used for many tasks. For example, web interfaces allow for searching the Internet, common search interfaces can find library collections, and search boxes are provided in many software tools. These interfaces are adequate for searching text, but are not able to search complicated graphic patterns. Graphic patterns are difficult to describe with text and may be associated with temporal information. These temporal relationships are difficult to present in a textual format.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to provide intelligent query for graphic patterns.

FIG. 2 is a block diagram illustrating an example embodiment of a visual analytics system and a query input system.

FIG. 3 is an example user interface for facilitating an intelligent query for graphic patterns.

FIG. 4 is another example user interface for facilitating an intelligent query for graphic patterns.

FIG. 5 is a user interface for sketching a graphic pattern according to one example embodiment.

FIG. 6 is a user interface for sketching a graphic pattern according to another example embodiment.

FIG. 7 is a user interface for providing limits to the graphic pattern according to example embodiments.

FIG.8 is a user interface for providing fuzzy inputs in the graphic pattern according to example embodiments.

FIG. 9 is a user interface for providing timeline inputs in the query according to example embodiments.

FIG. 10 is an illustration showing visualization on a desktop device according to example embodiments.

FIG. 11 is a user interface for modifying a past search according to example embodiments.

FIG. 12 is a flowchart of an example search.

FIG. 13. is a flowchart of an example method for providing intelligent query for graphic patterns.

FIG. 14 is a flowchart of an example method for modifying a previous search.

FIG. 15 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for performing an intelligent query for graphic patterns. In example embodiments, a touch-based system operating on a touch-based device augments a visual analytics desktop system that may perform the analysis of the query for results. In some embodiments, the visual analytics desktop system is a web-based visual analytics desktop system. The touch-based system enables a user to easily sketch patterns to be used as queries, apply filters or parameters, and otherwise control the visual analytics desktop system.

Accordingly, systems and methods for facilitating an intelligent query for a graphic pattern are provided. In example embodiments, a plurality of user interfaces is provided at a first device that is communicatively coupled to a second device having a visual analytics system. The plurality of user interfaces provides control of the visual analytics system of the second device at the first device. Sketch inputs are received via a sketch user interface of the plurality of user interfaces. The sketch inputs collectively generate a graphic pattern. A complex query is generated that includes the graphic pattern. The complex query is transmitted to the second device having the visual analytics system that performs a search for data that matches the complex query.

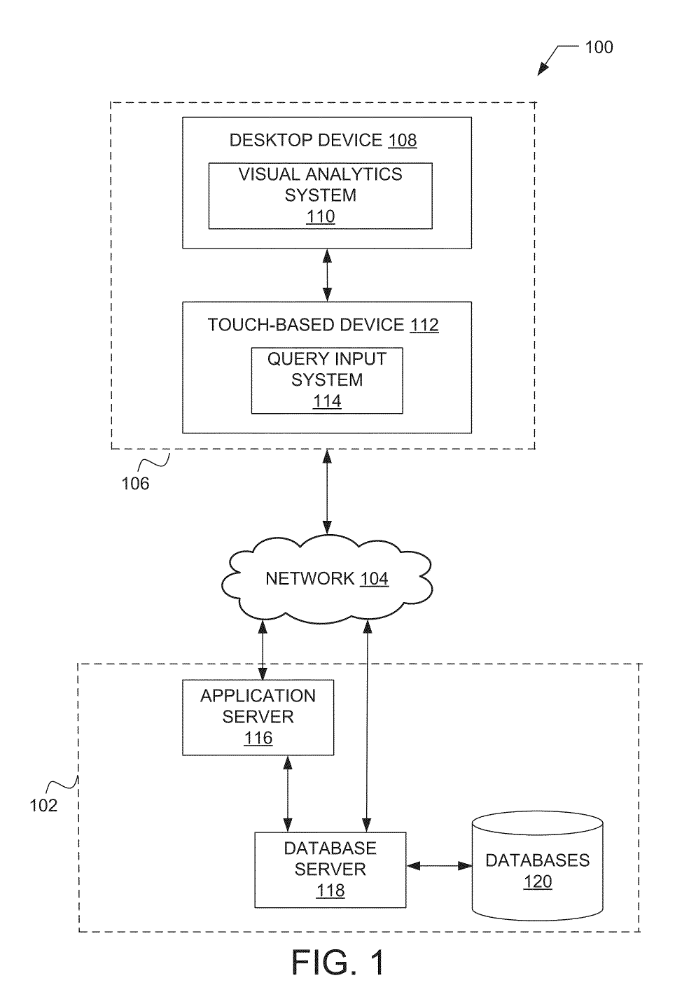

With reference to FIG. 1, an example embodiment of a high-level client-server-based network architecture 100 to perform intelligent query for graphic patterns is shown. A networked system 102, in an example form of a network-server-side functionality, is coupled via a communication network 104 (e.g., the Internet, wireless network, cellular network, a Local Area Network (LAN) or a Wide Area Network (WAN)) to a user system 106. The user system 106 comprises a desktop device 108 having a visual analytics system 110 communicatively coupled to a touch-based device 112 having a query input system 114. The desktop device 108 and the touch-based device 112 may be paired to communicate with each other via, for example, a communication handshake.

The desktop device 108 may comprise a desktop computer, laptop, or any other communication device that a user may utilize to access the networked system 102 and display visualizations of queries and corresponding results. As such, the desktop device 108 may comprise a display module (not shown) to display information (e.g., in the form of user interfaces). The visual analytics system 110 performs queries for graphical patterns and displays the results on the desktop device 108. However, use of a keyboard and mouse on the desktop device 108 to create the graphic patterns (also referred to as “sketches”) that are queried may be difficult compared to, for example, drawing on the touch-based device 114 using a finger or stylus. As a result, the touch-based device 112 is provided in the user system 106 to augment the functionalities of the visual analytics system 110. While a touch-based device 114 is described as augmenting the visual analytics system 110 at the desktop device 108, other types of devices may be used in alternative embodiments. For example, the user may “sketch” the graphic pattern using motion (e.g., drawing in air and having the motion captured by a camera).

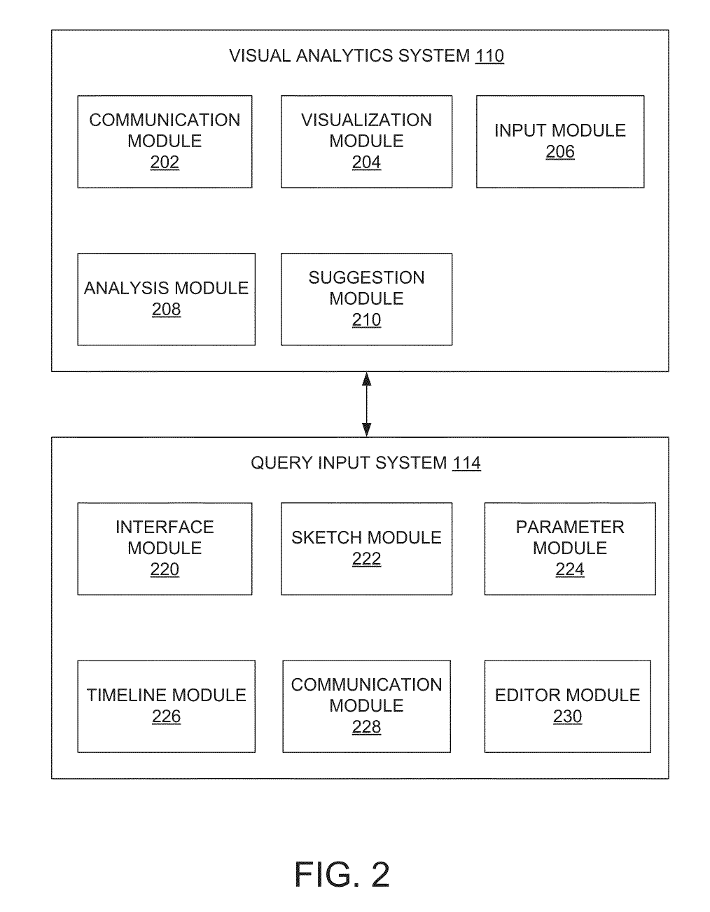

The touch-based device 112 may comprise a tablet, smartphone, or any other handheld device that is capable of receiving touch inputs (e.g., via a finger or a stylus) from the user. Accordingly, the touch-based device 112 includes a touch screen to receive the touch inputs from the user. The query input system 114 provides functionalities that allow the user to sketch graphic patterns, create complex queries comprising one or more graphic patterns, drag and drop previously created graphic patterns for reuse, and apply filters or parameters, among other functions using touch inputs. The visual analytics system 110, the query input system 114, and interaction between these two systems will be discussed in more detail in connection with FIG. 2.

The networked system 102 comprises an application server 116. In some embodiments, an Application Programming Interface (API) server or a web server (not shown) is coupled to, and provide programmatic and web interfaces respectively to the application server 116. In a web-based or software-as-a service (SaaS) embodiment, some of the functionality (e.g., modules, applications, or engines) of the visual analytics system 110 may be located at the application server 116 instead of at the desktop device 108. These modules, applications, or engines may be embodied as hardware, software, firmware, or any combination thereof. The application servers 116 are, in turn, coupled to a database server 118 facilitating access to one or more information storage repositories or databases 120. In one embodiment, the databases 120 are storage devices that store the data to be searched by the visual analytics system 110. The databases 120 may also, in some embodiments, store past searches and corresponding results. In some embodiments, the database server 118 may be accessed directly through the network 104.

While the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The visual analytics system 110 and query input system 114 may also be implemented as standalone systems or standalone software programs operating under separate hardware platforms, which do not necessarily have networking capabilities. For example, the visual analytics system 110 along with the databases 120 may be entirely on the user system 106 (e.g., desktop device 108 or touch-based device 112).

Referring now to FIG. 2, an example block diagram illustrating multiple components that, in one embodiment, are provided within the visual analytics system 110 and the query input system 114 are shown. The visual analytics system 110 performs queries for graphical patterns and displays the results on the desktop device 108, while the query input system 114 on the touch-based device 112 manages the creation of a complex query that includes at least one graphic pattern or sketch to be searched. To enable these operations, the visual analytics system 110 on the desktop device 108 comprises a communication module 202, a visualization module 204, an input module 206, an analysis module 208, and a suggestion module 210. The query input system 114 on the touch-based device 112 comprises an interface module 220, a sketch module 222, a parameter module 224, a timeline module 226, a communication module 228, and an editor module 230. The multiple components themselves are communicatively coupled (e.g., via appropriate interfaces), either directly or indirectly, to each other and to various data sources (e.g., the databases 120), to allow information to be passed between the components or to allow the components to share and access common data. While certain modules are shown in the visual analytics system 110 and other modules shown in the query input system 114, the modules may, alternatively, be located at both systems or in the other system. Additionally, functionalities of some modules may be combined into a single module or separated between two or more modules.

The communication module 202 of the visual analytics system 110 manages the exchange of data with various components. For example, the communication module 202 receives inputs from the touch-based device 112 such as sketch inputs and complex queries. The communication module 202 may also transmit suggestions for sketches to the touch-based device 112 as will be discussed in more detail below. Furthermore, the communication module 202 accesses the databases 120 to enable the analysis module 208 to perform the graphic pattern search.

The visualization module 204 manages the display of data at the desktop device 108. In example embodiments, the visualization module 204 may display sketch inputs as the user is creating the sketch on the touch-based device 112, and display results of a graphic pattern search, as well as provide various user interfaces that allow the user to edit, review, or modify search inputs (e.g., sketches, parameters, histories) and results.

The input module 206 manages traditional query inputs received from the user at the desktop device 108 that may be combined with the complex query received from the query input system 114. For example, the user may, use a keyboard, mouse, or touch screen of the desktop device 108, to identify one or more databases 120 that should be searched. In another example, the user may provide textual inputs via the keyboard that describe a certain parameter or filter (e.g., date range, run query on X number of databases, run query Y number of times with a different variable) of the graphic pattern search. These traditional query inputs are received by the input module 206 and provided to the analysis module 208. In some embodiments, the traditional query inputs may also be input at the query input system 114.

The analysis module 208 performs the graphic pattern search. In example embodiments, the analysis module 208 receives the complex query from the touch-based device 112 that may include one or more graphic patterns along with parameter inputs and timeline inputs. The graphic patterns, parameter inputs, and timeline inputs may be combined with any inputs received from the input module 206 and the aggregated complex query may be analyzed against the database 120 to determine results that match the complex query (e.g., graphic patterns, parameter inputs, timeline inputs, inputs from the input module 206).

The suggestion module 210 provides suggestions to the user as the user is sketching the graphic pattern on the touch-based device 112. In example embodiments, the suggestion module 210 may receive sketch inputs (e.g., nodes of the graphic pattern) as the user is sketching the graphic pattern. The suggestion module 210 may, through the communication module 202, access the database 120 and determine potential graphical patterns that match the sketch inputs so far, and provide suggestions for a next node of the graphic pattern being sketched. The next node may then be displayed to the user at the touch-based device 112.

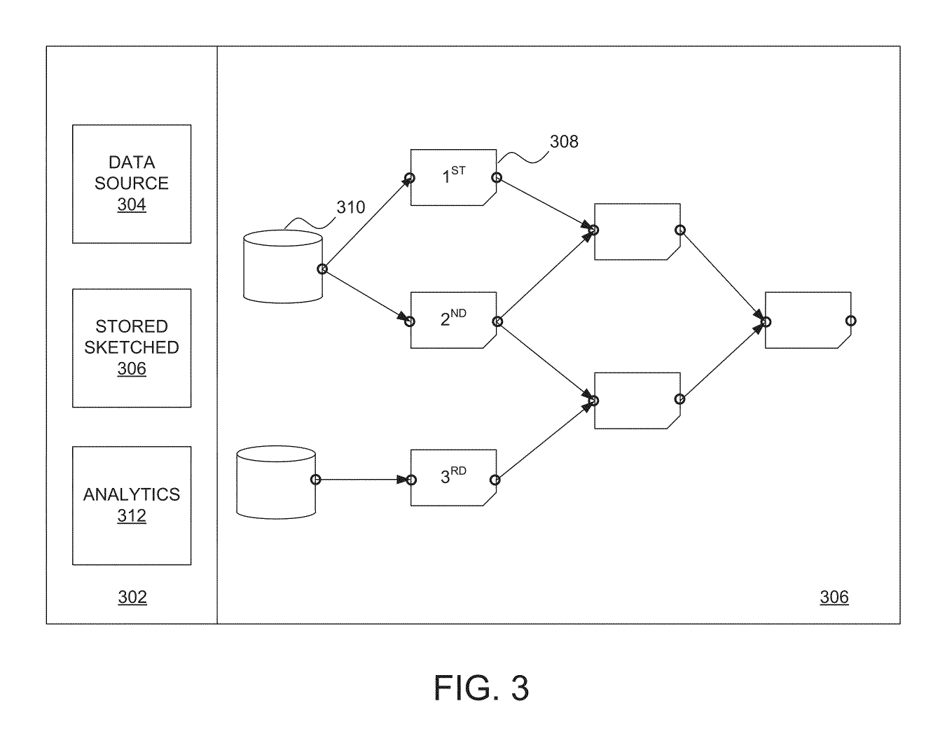

The interface module 220 provides user interfaces on the touch-based device 112 that enables the user to sketch graphic patterns, provide various parameters, or edit a previous search. In example embodiments, when the user initiates the query input system 114, the interface module 220 may provide a query user interface as depicted in FIG. 3. On a left panel 302 of the user interface, widgets are provided. The widgets may include data source identifiers 304 and a canvas 306 showing previous sketches created by the user. In some embodiments, once a sketch is created, the sketch can be saved for future use. The saved sketch may be dragged and dropped from the left panel 302 onto a canvas 306 (e.g., sketch 308). Similarly, data sources (e.g., input data) to be searched may be identified by dragging and dropping a representation of the data source (e.g., data source 310) to the canvas 306.

The canvas 306 comprises an area where a more complex query may be formed from one or more sketches and parameter inputs. For instance, the user can combine small sketches (e.g., a plurality of different graphic patterns) to form a more complex sketch. The sketches can be across different dimensions of underlying data. For example, each sketch may represent a different column in a spreadsheet, or may represent a single column in a spreadsheet, assuming that the underlying data is a multi-dimensional dataset whereby different columns are different dimensions of data. For instance, one sketch may be a query for height and a second sketch may be a query for weight. Alternatively, a plurality of sketches may be multiple queries for weight.

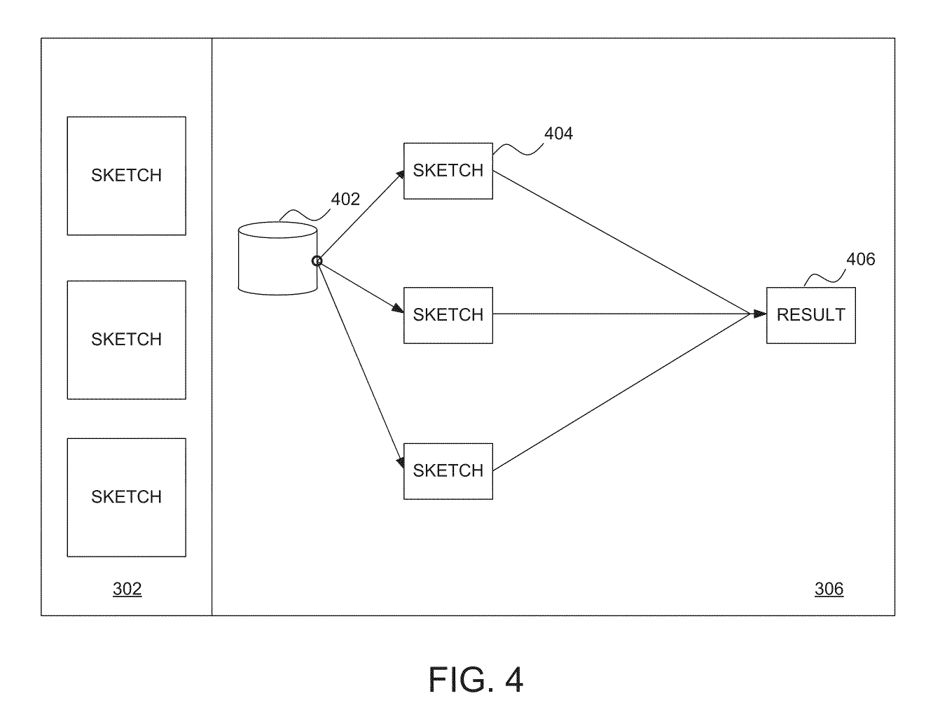

In some embodiments, the user may also drag and drop a previous search (e.g., from analytics 312). The dragging and dropping of the previous search (e.g., edit request) may cause the query user interface to present visual components of the previous search as shown in FIG. 4. The visual components may include input data 402 (e.g., one or more databases 120), the searched sketches 404, and a result 406. The left panel 302 now illustrates sketches, which may include the sketches 308. The user may edit the previous search by changing any of the input data 402, sketches 404, or input parameters (not shown) in order to obtain a different result 406.

Referring back to FIG. 2, the sketch module 222 manages the sketching of graphic patterns at the touch-based device 112. In one embodiment, the user may drag and drop a “sketch query” widget to the canvas 306, which causes a sketch user interface to be provided on the touch-based device 112. In alternative embodiments, the user may activate the sketch user interface using a drop down menu or other input means.

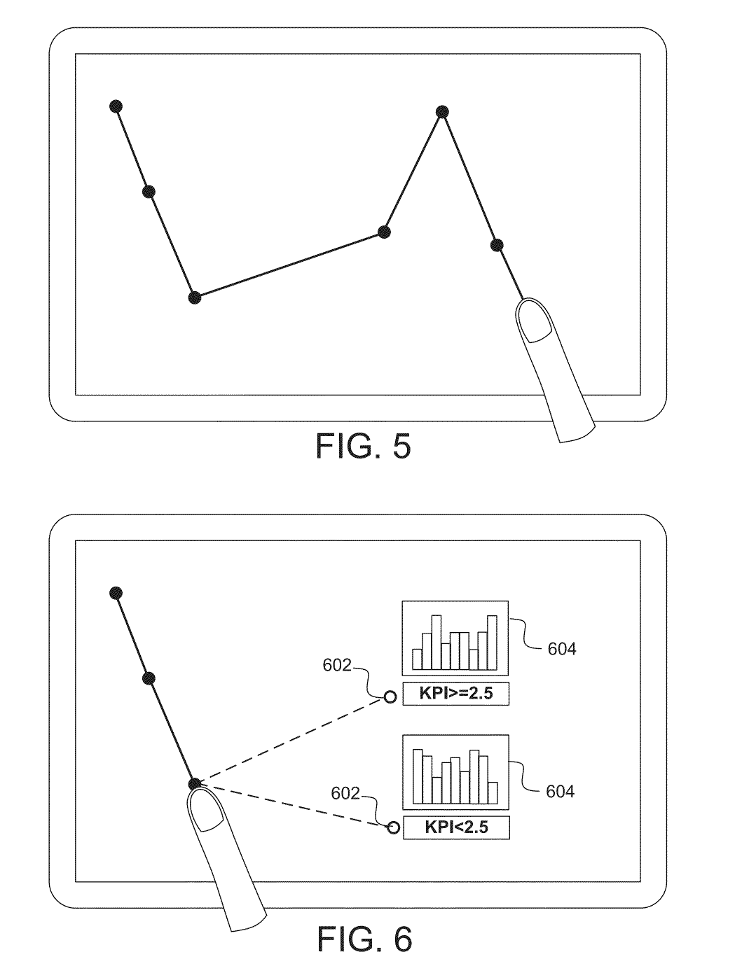

FIG. 5 illustrates a sketch user interface for sketching a graphic pattern according to one example embodiment. Use a touchscreen of the touch-based device 112, the user may draw a graphic pattern using an input device (e.g., finger, stylus, mouse). As the graphic pattern is drawn, anchor points or nodes may be positioned on the graphic pattern. The nodes may be adjusted by the user (e.g., by using a finger to drag and drop the node to a different position) to change a shape of the graphic pattern.

In some embodiments, suggestions may be presented to the user as the user is drawing the graphic pattern. For example and referring to FIG. 6, as the user is drawing the graphic pattern (e.g., the first three nodes), the communication module 202 at the visual analytics system 110 may receive the sketch inputs (e.g., the first three nodes) that collectively generate the graphic pattern, and the suggestion module 210 may determine one or more next possible positions for the fourth node. That is, while the user is drawing, the visual analytics system 110 is already searching the database 120 to find similar graphs or graphs that may be interesting based on the already drawn nodes. The suggestions are then transmitted back to the touch-based device 112 to be displayed to the user. As shown in FIG. 6, two potential next nodes 602 are displayed along a dashed line. In one embodiment, a popup message or window 604 may be displayed with each potential next node 602. The window 604 may provide a preview of results if the corresponding potential next node 602 is chosen. The window 604 may also provide an indication of what the value of the next node may be (e.g., KPI>2.5 or KPI<2.5).

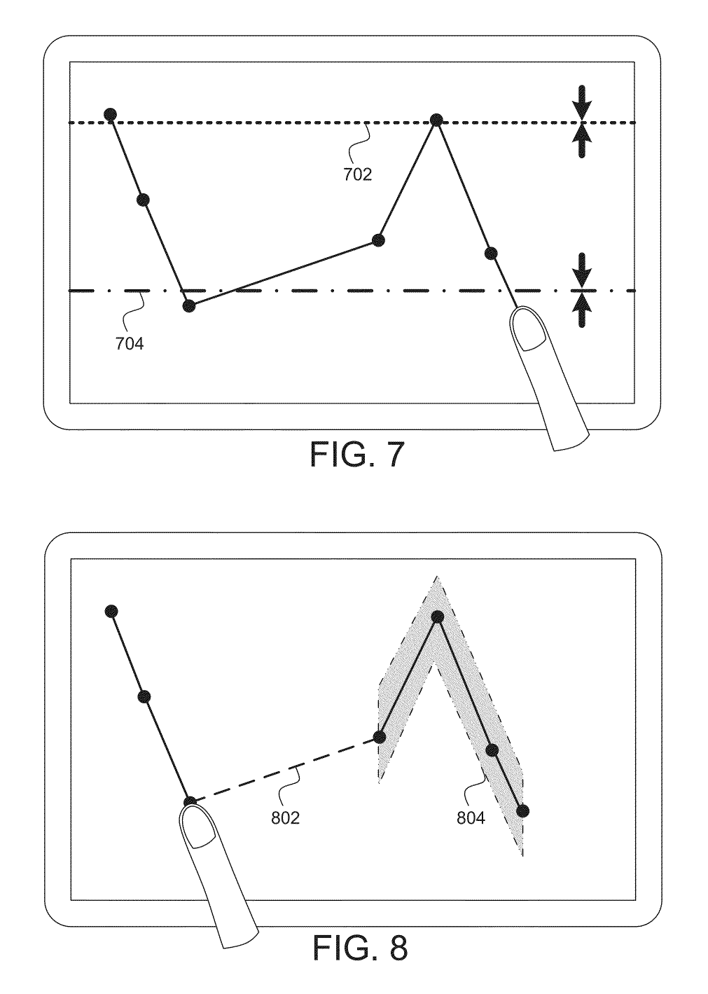

The sketch module 222 also allows the user to provide ranges or indicate if a particular section of the graphic pattern is “fuzzy” (e.g., has a level of ambiguity). Referring now to FIG. 7, the sketch user interface is shown with limits indicated for the graphic pattern according to example embodiments. For example, an upper boundary 702 and a lower boundary 704 are indicated on the sketch user interface, which may define the limits of the graphic pattern when queried.

FIG. 8 illustrates the sketch user interface having “fuzzy” inputs applied to the graphic pattern according to example embodiments. For example, if a particular section of the graphic pattern is unknown or undetermined, the user can change that section of the graphic pattern to a dashed line 802 (e.g., using a drop down menu or widget). Further still, the user may modify a line to a thicker line 804 or use a “brush tool” to draw the thicker line 804 to indicate a range for that section of the graphic pattern. In one embodiment, when specifying an upper or lower limit for a section of the graphic pattern (e.g., the thicker line 804), the sketch module 222 can provide options of having a “gradient brush” or “blur rendering ink” to allow the user to specify a range with ambiguities instead of binary inputs.

Referring back to FIG. 2, the parameter module 224 manages parameter inputs when creating the complex query having the graphic pattern. In some embodiments, the widgets provided by the user interface may include logical operations such as AND, OR, XOR, or NOT. As such, the user can apply one or more of these logical operations or parameters to the query. For example and referring to back to FIG. 3, the user can match a first graphic pattern or a second graphic pattern (e.g., OR operation), or the user may want to exclude the third graphic pattern (e.g., NOT operation). Any combination of graphic patterns may be created to form the complex query by using the various logical operations. In one embodiment, the logical operations may be dragged and dropped on the graphic pattern or line connecting two components (e.g., the data source 310, any graphic pattern) to indicate the logic operation to be applied. In an alternative embodiment, a drop down menu may be used to specify the logical operation. The logical operation may be specified when the user connects two of the components. The result of the application of the parameters to the graphic patterns creates the complex query. The complex query may be saved (e.g., in the stored sketches or analytics 312) for future searches. The complex query may be, in some embodiments, one sketch (e.g., composite graphic pattern) composed of several different sketches (e.g., a plurality of graphical patterns).

The timeline module 226 manages temporary inputs applied to the query. As previously discussed, the user can combine small sketches (e.g., a plurality of different graphic patterns) to form a more complex query. The different graphic patterns can be across different dimensions of underlying data. In example embodiments, the user may want one graphic pattern to occur before another graphical pattern, multiple graphic patterns to occur at a same time, or a plurality of graphic patterns to partially overlap. Accordingly, the timeline module 226 provides an interface that allows the user to indicate these temporal inputs.

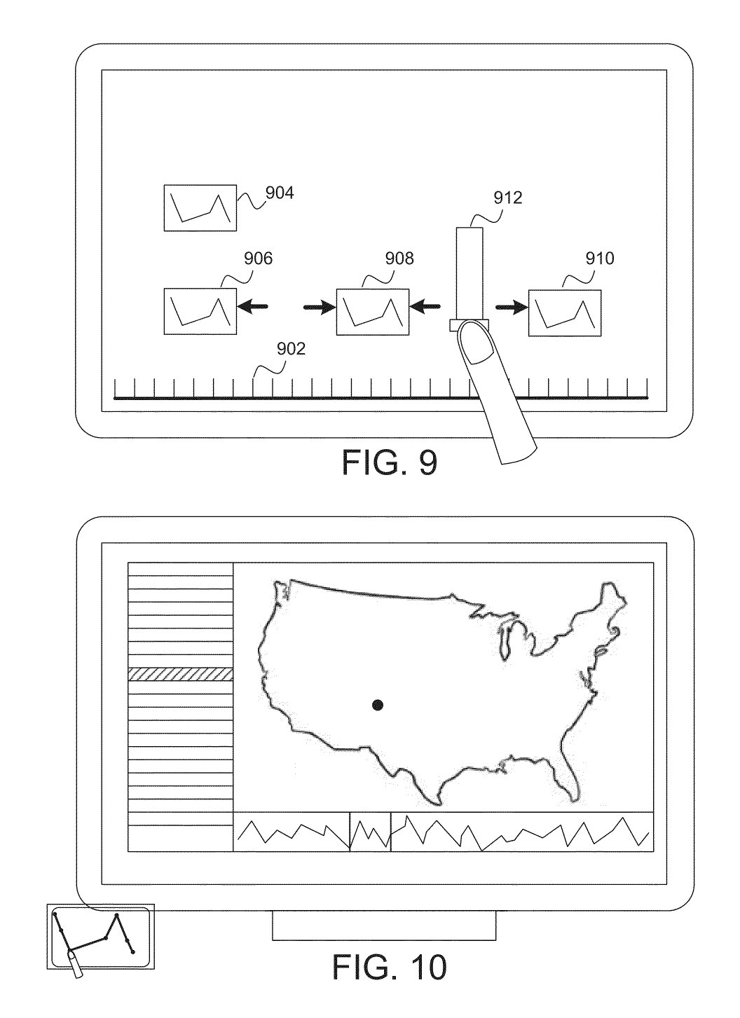

FIG. 9 shows a query user interface having a timeline 902 that guides the user in providing temporal inputs. As shown, four different graphic patterns are selected for the complex query. A first graphic pattern 904 and a second graphic pattern 906 are aligned to occur at a same time. For example, the first graphic pattern 904 may represent temperature and the second graphic pattern 906 may represent pressure. A third graphic pattern 908 is aligned to occur, in the complex query, a particular time interval after the first and second graphic patterns 904 and 906. Similarly, a fourth graphic pattern 910 is aligned to occur a certain time interval after the third graphic pattern 908. In one embodiment, the user may drag and drop the various graphic patterns along the timeline 902. Alternatively or additionally, the user may adjust or fine tune a time interval between two graphic patterns using, for example, a slider mechanism 912 (e.g., moving a slider up will increase the time interval, and vice-versa).

As previously discussed with respect to the suggestion module 210, sketch inputs (e.g., nodes of the graphic pattern) may be received in real-time by the desktop device 108 (e.g., the visual analytics system 110) as the user is sketching the graphic pattern on the touch-based device 112. Similarly, other inputs, such as logical operation inputs, timeline inputs, changes to the graphic pattern (e.g., move node, delete node, add node) may be received in real-time by the visual analytics system 110 at the desktop device 108. As such, the visualization module 204 may continuously update as inputs or graphic patterns on the touch-based device 112 change, and any changes made on the touch-based device 112 are immediately shown on the desktop device 108. FIG. 10 is an illustration showing a visualization on the desktop device 108 as the user is providing inputs at the touch-based device 112.

Referring back to FIG. 2, the editor module 230 manages edits made to previous queries. Each query along with any changes (e.g., moving node, deleting node, timeline inputs) is saved to a history (e.g., by the analysis module 208). As a result, the user may access a previous query or even a current query and change one or more variables to obtain a different result. In some embodiments, the history may be locally stored at the touch-based device 112. In other embodiments, the history may be stored at the desktop device 108 and accessed via the communication module 228. Further still, the history may be stored at the database 120 and accessed either by the touch-based device 112 directly or through the desktop device 108.

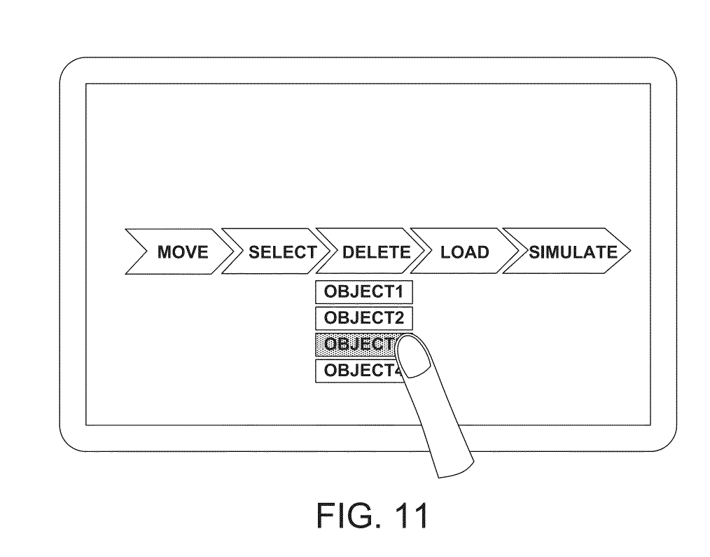

FIG. 11 is a user interface displaying a past query according to example embodiments. In one example, the user may select (e.g., provide an edit request) a particular past query (e.g., analytics 312) on the touch-based device 112, and the past query, in a form of blocks, is displayed to the user. In this example, the user may have done something incorrectly or just decided to change a variable. As such, the user can go back and make a change or edit to a variable or component. In the present example, the user does not want to delete object 3, so the user may go back and remove that delete as shown. Alternatively, the user may want to delete object 1 instead of object 3. The user may select the delete block and select an object to un-delete and/or delete. A new branch in the history is created based on the change in variable and stored. This new branch, itself, can be further changed and further branches created. As such, the editor module 230 provides a user-friendly and simple way for the user to change previous queries.

Although the various components of the visual analytics system 110 and the query input system 114 have been defined in terms of a variety of individual modules and engines, a skilled artisan will recognize that many of the components can be combined or organized in other ways and that not all modules or engines need to be present or implemented in accordance with example embodiments. Furthermore, not all components of the visual analytics system 110 and the query input system 114 have been included in FIG. 2. In general, components, protocols, structures, and techniques not directly related to functions of exemplary embodiments have not been shown or discussed in detail. The description given herein simply provides a variety of exemplary embodiments to aid the reader in an understanding of the systems and methods used herein.

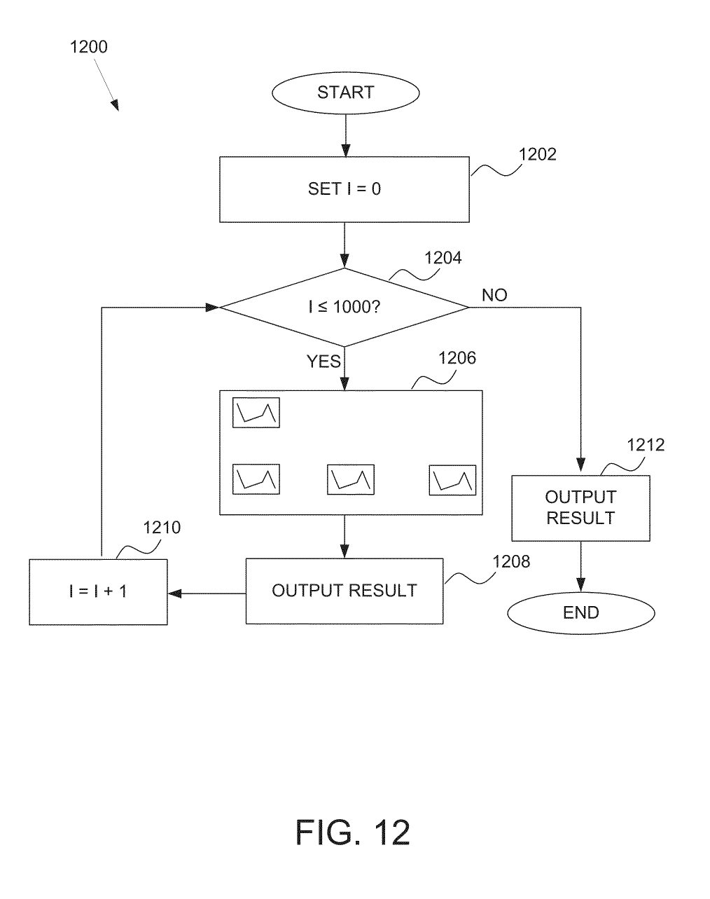

FIG. 12 is a flowchart illustrating an example search 1200. In the example search 1200, the user may specify a traditional query input that indicates the query should run 1001 times. The traditional query input may be, for example, entered into a field using the input module 206 on the desktop device 108 or the parameter module 224 on the touch-based device 112. As such, at operation 1202, a counter is initialized to 0. In operation 1204, a determination is made as to whether the counter is less than or equal to 1000. If the counter is less than or equal to 1000, then an analysis is performed in operation 1206 using the complex query. In the present example, the complex query may include four graphic patterns temporally aligned. A result of the complex query is output in operation 1208, and the counter is incremented by 1 in operation 1210. The system continues to perform the analysis until the counter reaches 1000 at which time, a final result is output in operation 1212 and the analysis ends. It is noted that FIG. 12 illustrates just one example of a search, and alternative example may comprise other parameters and variables.

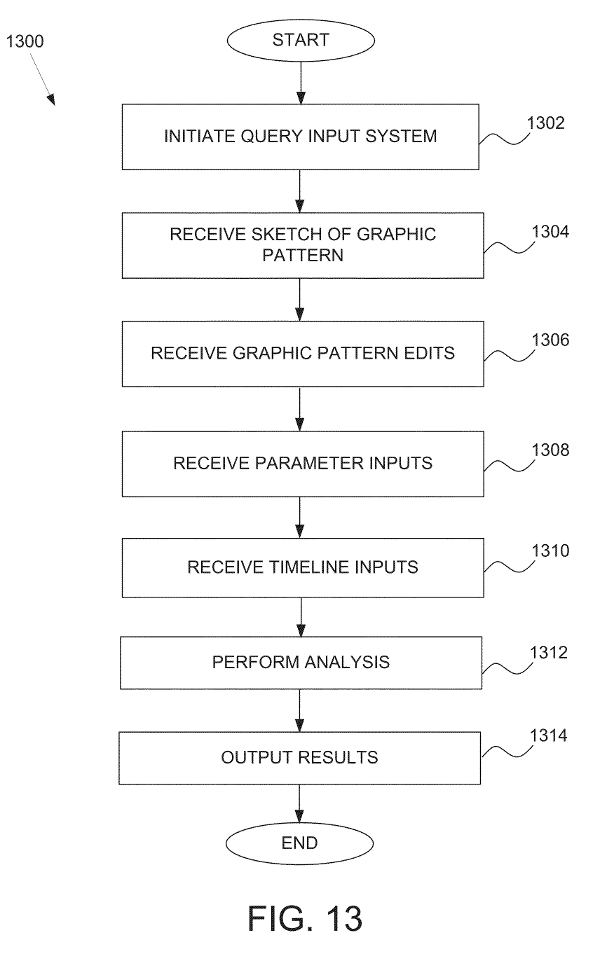

FIG. 13. is a flowchart of an example method 1300 for facilitating an intelligent query for graphic patterns. In operation 1302, the query input system 114 is initiated on the touch-based device 112. In example embodiments, the interface module 220 may provide user interfaces on the touch-based device 112 that enables the user to sketch graphic patterns, provide various parameters, or edit a previous search. In one embodiment, the user may drag and drop a “sketch query” widget to the canvas 306 or otherwise indicate activation of a sketch user interface to be provided on the touch-based device 112. In alternative embodiments, the user may activate the sketch user interface using a drop down menu or other input means.

In operation 1304, a sketch of a graphic pattern is received. In example embodiments, the user may use the touchscreen of the touch-based device 112 to draw the graphic pattern using an input device (e.g., finger, stylus, mouse). As the graphic pattern is drawn, anchor points or nodes may be positioned on the graphic pattern. In some embodiments, suggestions may be presented to the user as the user is drawing the graphic pattern. These suggestions are received by the suggestion module 210.

In operation 1306, edits to the graphic pattern may be received. For example, the nodes on the graphic pattern may be adjusted by the user (e.g., by using a finger to drag and drop the node to a different position) to change a shape of the graphic pattern. Additionally, the sketch module 222 allows the user to provide ranges for a portion of the graphic pattern, provide boundaries for the entire graphic pattern, indicate if a particular section is unknown or undetermined, or indicate if a particular section of the graphic pattern is “fuzzy” (e.g., has a level of ambiguity).

It is noted that operations 1304 and 1306 may occur simultaneously. For example, as the graphic pattern is being sketched in operation 1304, the graphic pattern may be edited. Additionally, operations 1304 and 1306 may occur recursively until the user has created all the graphic patterns that the user desires to search.

In operation 1308, parameter inputs are received by the touch-based device 112. In example embodiments, the parameter module 224 manages parameter inputs for creating a complex query comprising a plurality of graphic patterns sketched and edited in operations 1304 and 1306 (or a previous graphic pattern retrieved from storage). In some embodiments, the user may apply logical operations such as AND, OR, XOR, or NOT. The result of the application of these logical operations or parameters to the graphic patterns creates a single complex query. The complex query is, in essence, one sketch (e.g., composite graphic pattern) composed of several different sketches (e.g., a plurality of graphical patterns).

In operation 1310, timeline inputs may be received at the touch-based device 112. In example embodiments, the timeline module 226 manages temporary inputs applied to the various graphic patterns in the complex query by providing a timeline that allows a user to indicate temporal inputs. As discussed, the user can combine a plurality of different graphic patterns to form the complex query. In one embodiment, the user may drag and drop the various graphic patterns along the timeline to create the complex query. For example, the user may drag and drop graphic patterns to change a temporal order of the graphic pattern (e.g., have one graphic pattern occurring before a second graphic pattern). Alternatively or additionally, the user may adjust or fine tune a time interval between two graphic patterns using a slider mechanism to create the complex query.

In operation 1312, analysis is performed using the complex query. In example embodiments, the graphic patterns and inputs received at the touch-based device 112 are transmitted to the visual analytics system 110 at the desktop device 108 substantially simultaneously as the graphic patterns and inputs are entered into the touch-based device 112. As such, the analysis module 208 may, in one embodiment, be performing the analysis as the graphic patterns and inputs are received, and not necessarily only when the final complex query is generated. Alternatively, the analysis module 208 may wait until the complex query is generated before performing the analysis. In either embodiment, the results of the analysis may be queued (e.g., in memory) to allow for faster access to the results by the touch-based device 112 and the desktop device 108.

The results of the analysis are output (e.g., a results user interface) in operation 1314. The results may be displayed both on the desktop device 108 as well as on the touch-based device 112.

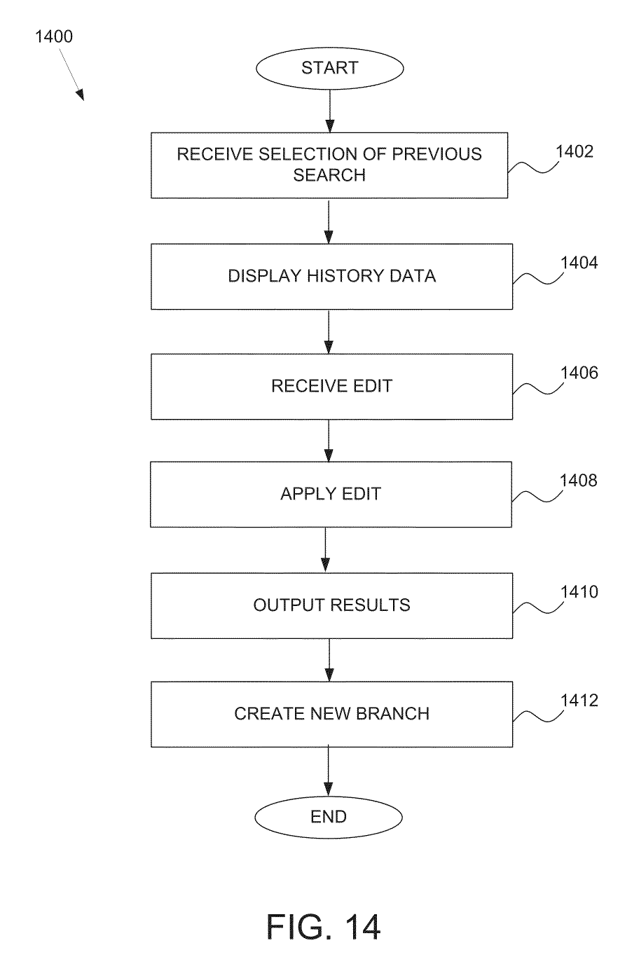

FIG. 14 is a flowchart of an example method 1400 for modifying a previous search. In operation 1402, a selection of a previous search or query is received. In one embodiment, the user may drag and drop a previous query on the canvas 306 on the touch-based device 112. Alternatively, other mechanisms for selecting a previous search may be used.

In operation 1404, details of the previous query are displayed to the user. For example, the dragging and dropping of the previous query may cause a query user interface to present visual components of the previous query (e.g., as shown in FIG. 4) that may include input data (e.g., from one or more databases 120), the searched sketches or graphic patterns, and a result. In an alternative example, the previous search may be displayed in a form of blocks that form a history for the prior search (e.g., as shown in FIG. 11).

Edits to variables are received in operation 1406. The edits may comprise changes to one or more graphic patterns, changes to one or more nodes in a graphic pattern, changes to logic operations or timeline inputs, and so forth. As such, any input can be changed to generate a different result. In the block embodiment, the user can select a block corresponding to an operation (e.g., delete, move, select, load), and select a different variable, delete a variable, or add a variable.

The edits are applied in operation 1408. In example embodiments, the analysis module 208 performs a new analysis based on the revised query. The results are output in operation 1410. Accordingly, the results may be displayed both on the desktop device 108 as well as on the touch-based device 112.

In operation 1412, a new branch or new search history is created and stored. The new branch or new search history can then be further edited to create further new branches or search histories.

According to various example embodiments, one or more of the methodologies described herein may facilitate searching of graphic patterns. The methodologies described herein may also facilitate the searching of graphic patterns using an interface that allows the user to easily sketch out patterns and to perform different types of pattern searches. Further still, the user interface receives parameter and timeline inputs in an efficient manner. When these effects are considered in aggregate, one or more of the methodologies described herein may obviate a need for certain efforts or resources that otherwise would be involved in performing a search of graphic patterns. Efforts expended by a user in performing a search of graphic patterns may be reduced by one or more of the methodologies described herein. Computing resources used by one or more machines, databases 120, or devices (e.g., within the network architecture 100) may similarly be reduced. Examples of such computing resources include processor cycles, network traffic, memory usage, data storage capacity, power consumption, and cooling capacity.

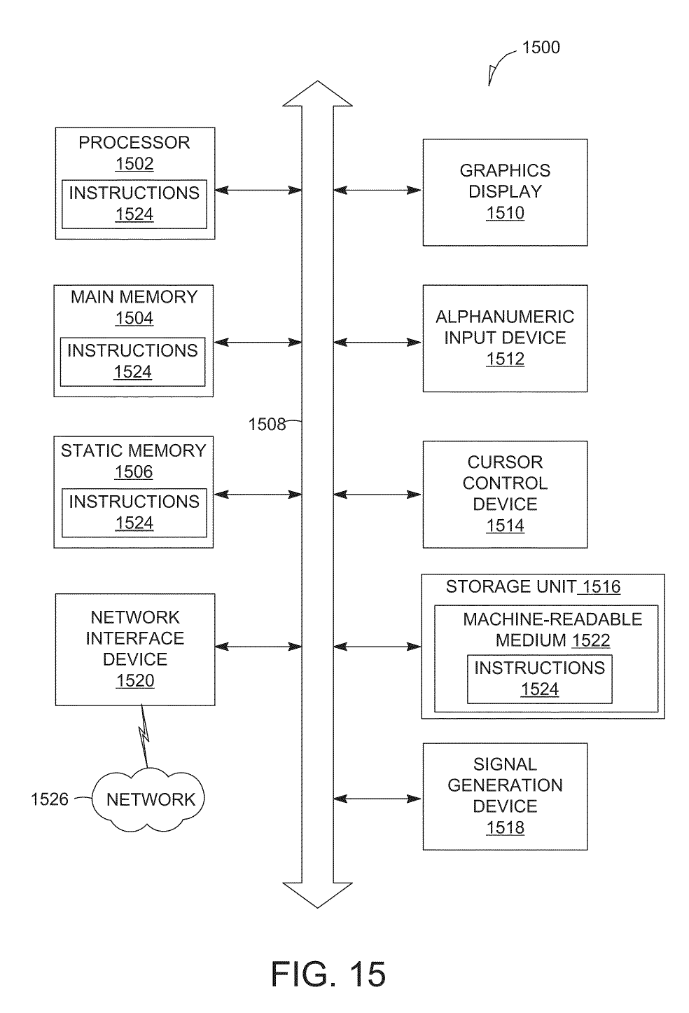

FIG. 15 is a block diagram illustrating components of a machine 1500, according to some example embodiments, able to read instructions 1524 from a machine-readable medium 1522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 15 shows the machine 1500 in the example form of a computer system (e.g., a computer) within which the instructions 1524 (e.g., software, a program, an application, an applet, an app, or other executable code) for causing the machine 1500 to perform any one or more of the methodologies discussed herein may be executed, in whole or in part.

In alternative embodiments, the machine 1500 operates as a standalone device or may be connected (e.g., networked) to other machines. In a networked deployment, the machine 1500 may operate in the capacity of a server machine or a client machine in a server-client network environment, or as a peer machine in a peer-to-peer (or distributed) network environment. The machine 1500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1524, sequentially or otherwise, that specify actions to be taken by that machine. Further, while only a single machine is illustrated, the term “machine” shall also be taken to include a collection of machines that individually or jointly execute the instructions 1524 to perform any one or more of the methodologies discussed herein.

The machine 1500 includes a processor 1502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1504, and a static memory 1506, which are configured to communicate with each other via a bus 1508. The processor 1502 may contain microcircuits that are configurable, temporarily or permanently, by some or all of the instructions 1524 such that the processor 1502 is configurable to perform any one or more of the methodologies described herein, in whole or in part. For example, a set of one or more microcircuits of the processor 1502 may be configurable to execute one or more modules (e.g., software modules) described herein.

The machine 1500 may further include a graphics display 1510 (e.g., a plasma display panel (PDP), a light emitting diode (LED) display, a liquid crystal display (LCD), a projector, a cathode ray tube (CRT), or any other display capable of displaying graphics or video). The machine 1500 may also include an alphanumeric input device 1512 (e.g., a keyboard or keypad), a cursor control device 1514 (e.g., a mouse, a touchpad, a trackball, a joystick, a motion sensor, an eye tracking device, or other pointing instrument), a storage unit 1516, a signal generation device 1518 (e.g., a sound card, an amplifier, a speaker, a headphone jack, or any suitable combination thereof), and a network interface device 1520.

The storage unit 1516 includes the machine-readable medium 1522 (e.g., a tangible and non-transitory machine-readable storage medium) on which are stored the instructions 1524 embodying any one or more of the methodologies or functions described herein. The instructions 1524 may also reside, completely or at least partially, within the main memory 1504, within the processor 1502 (e.g., within the processor's cache memory), within the static memory 1506, or all of these, before or during execution thereof by the machine 1500. Accordingly, the main memory 1504, static memory 1506, and the processor 1502 may be considered machine-readable media 1522 (e.g., tangible and non-transitory machine-readable media).

In some example embodiments, the machine 1500 may be a portable computing device, such as a smart phone or tablet computer, and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e.g., a centralized or distributed database, or associated caches and servers) able to store instructions 1524. The term “machine-readable medium” shall also be taken to include any medium, or combination of multiple media, that is capable of storing instructions 1524 for execution by a machine (e.g., machine 1500), such that the instructions 1524, when executed by one or more processors of the machine (e.g., processor 1502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium 1522 is non-transitory in that it does not embody a propagating signal. However, labeling the tangible machine-readable medium 1522 as “non-transitory” should not be construed to mean that the medium is incapable of movement—the medium should be considered as being transportable from one physical location to another. Additionally, since the machine-readable medium 1522 is tangible, the medium may be considered to be a machine-readable device.

The instructions 1524 may further be transmitted or received over a communications network 1526 using a transmission medium via the network interface device 1520 and utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 1524 for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
providing a plurality of user interfaces at a first device that is communicatively coupled to a second device having a visual analytics system, the plurality of user interfaces providing control, at the first user device, of the visual analytics system of the second device;
receiving sketch inputs via a sketch user interface of the plurality of user interfaces, the sketch inputs collectively generating a graphic pattern;
creating, by a hardware processor, a complex query using the graphic pattern;
transmitting the complex query to the second device having the visual analytics system that performs a search for data that matches the complex query; and
causing a result of the search to be displayed.

2. The method of claim 1, wherein:
the first device is a touch-based device, and
the receiving the sketch inputs comprises receiving the sketch inputs via a touchscreen of the touch-based device.

3. The method of claim 1, wherein the sketch inputs comprise a dashed line indicating an unknown section of the graphic pattern.

4. The method of claim 1, wherein the sketch inputs comprise a fuzzy input indicating a range for a section of the graphic pattern.

5. The method of claim 1, wherein the sketch inputs comprise an upper boundary or a lower boundary for the graphic pattern.

6. The method of claim 1, wherein the creating the complex query comprises combining a plurality of graphic patterns to be searched.

7. The method of claim 6, wherein the creating the complex query comprises receiving at least one logic operation to apply to at least one of the plurality of graphic patterns.

8. The method of claim 6, wherein creating the complex query comprises:
providing a query user interface on the first device;
receiving a temporal input via the query user interface, the temporal input defining a time interval to be applied between two graphic patterns of the plurality of graphic patterns.

9. The method of claim 8, wherein the receiving the temporal input comprises detecting a drag and drop of the two graphic patterns along a timeline displayed on the query user interface, the drag and drop changing a temporal order of the two graphic patterns.

10. The method of claim 8, wherein the receiving the temporal input comprises adjusting a timing mechanism to change the time interval between the two graphic patterns.

11. The method of claim 1, further comprising providing a suggestion for a potential next node as the user is sketching the graphic pattern.

12. The method of claim 1, further comprising:
receiving an edit request, the edit request indicating a previous query to be edited;
retrieving the previous query from a data source;
displaying visual components of the previous query;
receiving an edit to one of the visual components to change the previous query to a revised query;
analyzing the revised query to obtain a new result; and
saving the edit and new result as a new branch in a data source history.

13. The method of claim 12, wherein:
the visual components comprises a plurality of blocks that indicate a previous operation; and
the receiving the edit comprises receiving a selection of a block from the plurality of blocks, the selection causing a drop down menu of editable variables for the selected block, and receiving a selection of an editable variable.

14. A machine-readable medium having no transitory signals and storing instructions which, when executed by the at least one processor of a machine, cause the machine to perform operations comprising:
providing a plurality of user interfaces at a first device that is communicatively coupled to a second device having a visual analytics system, the plurality of user interfaces providing control, at the first device, of the visual analytics system of the second device;
receiving sketch inputs via a sketch user interface of the plurality of user interfaces, the sketch inputs collectively generating a graphic pattern;
creating a complex query that includes the graphic pattern;
transmitting the complex query to the second device having the visual analytics system that performs a search for data that matches the complex query; and
causing a result of the search to be displayed.

15. The machine-readable medium of claim 14, wherein the sketch inputs comprise a dashed line indicating an unknown section of the graphic pattern.

16. The machine-readable medium of claim 14, wherein the sketch inputs comprise a fuzzy input indicating a range for a section of the graphic pattern.

17. The machine-readable medium of claim 14, wherein the creating the complex query comprises combining a plurality of graphic patterns to be searched.

18. The machine-readable medium of claim 17, wherein the creating the complex query comprises receiving at least one logic operation to apply to at least one of the plurality of graphic patterns.

19. The machine-readable medium of claim 17, wherein creating the complex query comprises:
providing a query user interface on the first device;
receiving a temporal input via the query user interface, the temporal input defining a time interval to be applied between two graphic patterns of the plurality of graphic patterns.

20. A system comprising:
a hardware-implemented interface module to provide a plurality of user interfaces at a first device that is communicatively coupled to a second device having a visual analytics system, the plurality of user interfaces providing control of the visual analytics system of the second device at the first device;
a sketch module, implemented by at least one processor, to receive sketch inputs via a sketch user interface of the plurality of user interfaces, the sketch inputs collectively generating a graphic pattern that forms a part of a complex query; and
a hardware-implemented communication module to transmit the complex query to the second device having the visual analytics system that performs a search for data that matches the complex query.
